(19) United States
(12) Patent Application Publication
(10) Pub. No.: US 2025/0209726 A1
(43) Pub. Date: Jun. 26, 2025

(54) PATH GUIDING USING NEURAL RADIANCE CACHING WITH RESAMPLED IMPORTANCE SAMPLING

(71) Applicant: DISNEY ENTERPRISES, INC., Burbank, CA (US)

(72) Inventors: Farnood SALEHI, Zürich (CH); Marios PAPAS, Opfikon (CH); Tiziano PORTENIER, Bern (CH); Marco MANZI, Zürich (CH); Saeed HADADAN, Hyattsville, MD (US)

(21) Appl. No.: 18/990,819

(22) Filed: Dec. 20, 2024

Related U.S. Application Data
(60) Provisional application No. 63/613,616, filed on Dec. 21, 2023.

(51) Int. Cl. G06T 15/06; G06T 1/60; G06T 15/00; G06T 15/50

(52) U.S. Cl. CPC G06T 15/06; G06T 1/60; G06T 15/005; G06T 15/506

(57) ABSTRACT

The present invention sets forth techniques for performing path guiding. The techniques include receiving a representation of a three-dimensional (3D) scene and a virtual camera location and generating a lightpath that originates at the virtual camera location and reaches a point included in the 3D scene. The techniques also include selecting, from a set of candidate directions, a direction in which to extend the generated lightpath from the point, wherein the selecting is based at least on one or estimates of incident light characteristics associated with the 3D scene predicted by a machine learning model. The techniques further include extending the generated lightpath in the selected direction and generating a two-dimensional (2D) rendering of the 3D scene, based at least on the generated lightpath.

### CROSS-REFERENCE TO RELATED APPLICATIONS

This application claims priority benefit to U.S. Provisional application titled “PATH GUIDING USING NEURAL RADIANCE CACHING WITH RESAMPLED IMPORTANCE SAMPLING,” filed on Dec. 21, 2023, and having Ser. No. 63/613,616. This related application is also hereby incorporated by reference in its entirety.

### BACKGROUND

### Field of the Various Embodiments

Embodiments of the present disclosure relate generally to computer graphics and, more specifically, to techniques for performing path guiding using neural radiance caching with resampled importance sampling.

### DESCRIPTION OF THE RELATED ART

In the field of computer graphics, rendering includes the process of generating an image of a scene based on a two-dimensional (2D) or three-dimensional (3D) representation of the scene. The 2D or 3D representation of the scene may include geometry, texture, lighting, and/or shading information describing the scene. In particular, the 2D or 3D representation may include information describing one or more light sources included in the scene.

One technique for calculating lighting effects in a rendered image of a scene includes generating multiple lightpaths associated with a virtual camera viewpoint. Each lightpath describes a trajectory that potentially connects the virtual camera to a light source included in the scene, and may include multiple scattering events or bounces based on the location of the virtual camera, the location of the one or more light sources, and the positions and surface characteristics associated with one or more objects included in the scene. Each interaction between a lightpath and one or more surfaces included in the scene may change the direction, color, and/or intensity of the reflected or scattered light and provided visual information associated with a location included in the rendered image.

Generating multiple lightpaths may be computationally expensive, as there may be millions or billions of possible lightpaths potentially connecting a virtual camera to each of multiple light sources via an arbitrary number of reflections or bounces. Further, many of the generated light paths may never reach a light source, even after multiple reflections or scattering events. These light paths do not generate any color or lighting information for locations within the scene, and do not contribute to pixel color values included in the final rendered image of the scene.

Monte Carlo path tracing is an example of a rendering technique that attempts to reduce the computational expense associated with generating lightpaths. Monte Carlo path tracing techniques stochastically sample a subset of all possible lightpaths, based on a determination of which lightpaths are more likely to reach one of one or more light sources included in a scene and therefore contribute to pixel values included in the final rendered image of the scene. Monte Carlo path tracing techniques may further include one or more path guiding techniques that inform the selection of lightpaths based on learned quantities related to the radiance distribution in a scene. Path guiding techniques may reduce the amount of variance or other error in a final rendered image of the scene.

Existing path guiding methods may employ parametric distributions or shallow models, e.g. tree-based parametric distributions, to describe the radiance characteristics of a scene. These parametric distributions may include simple mixtures of analytical distributions, such as Gaussian distributions or von Mises-Fisher distributions. These methods are trained independently for each spatial location in a scene and may overlook the global scene context, leading to variance and other errors in the rendered image.

Other existing path guiding methods may train a neural network representation of a scene, including radiance information associated with the scene. By training a single neural network representation for the entire scene, these techniques leverage all samples to train the representation, allowing the representation to learn the overall light distribution across the 3D scene. For example, a Neural Parametric Mixture (NPM) path guiding technique may train a Multilayer Perceptron Network (MLP) to predict parameters for a von Mises-Fisher parametric model. However, these methods are bound by the limitations of the underlying parametric model, and may not accurately estimate complex light distributions.

Still other existing path methods, such as Neural Importance Sampling (NIS), may employ a normalized flow neural network representation of the scene lighting to guide the selection of lightpaths. These normalizing flow networks allow for direct generation of samples within the 3D scene, as well as the subsequent computation of probability distribution functions that inform the path tracing technique's selection of a lightpath direction resulting from a reflection or other bounce event. One drawback to these techniques as that the chosen neural network representation of the scene must be invertible, such that specifying an output value of the neural network representation would allow a determination of one or more input values corresponding to the output value. This invertibility requirement may limit the overall representation capacity of the neural network representation and introduce additional complexities necessary to ensure the invertibility of the network.

As the foregoing illustrates, what is needed in the art are more effective techniques for path guiding when generating lightpaths during rendering.

### SUMMARY

One embodiment of the present inventions sets for a technique for performing path guiding. The technique includes receiving a representation of a three-dimensional (3D) scene and a virtual camera location and generating a lightpath that originates at the virtual camera location and reaches a point included in the 3D scene. The technique also includes selecting, from a set of candidate directions, a direction in which to extend the generated lightpath from the point, wherein the selecting is based at least on one or estimates of incident light characteristics associated with the 3D scene and predicted by a machine learning model. The technique further includes extending the generated lightpath in the selected direction, and generating a two-dimensional (2D) rendering of the 3D scene based at least on the generated lightpath.

One technical advantage of the disclosed techniques relative to the prior art is that the disclosed techniques include an expressive, accurate learned neural representation of incident and/or reflected radiance associated with a scene, rather than a limited parametric model. However, the disclosed techniques are operable to sample from a parametric model as well. Further, the disclosed techniques do not require that the learned neural representation be invertible or normalized, although they are also operable to sample invertible and/or normalized learned neural representations. These techniques reduce the necessary complexity of the neural representation and increase the accuracy of the final rendered image. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is a flow diagram of method steps for generating a lightpath, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

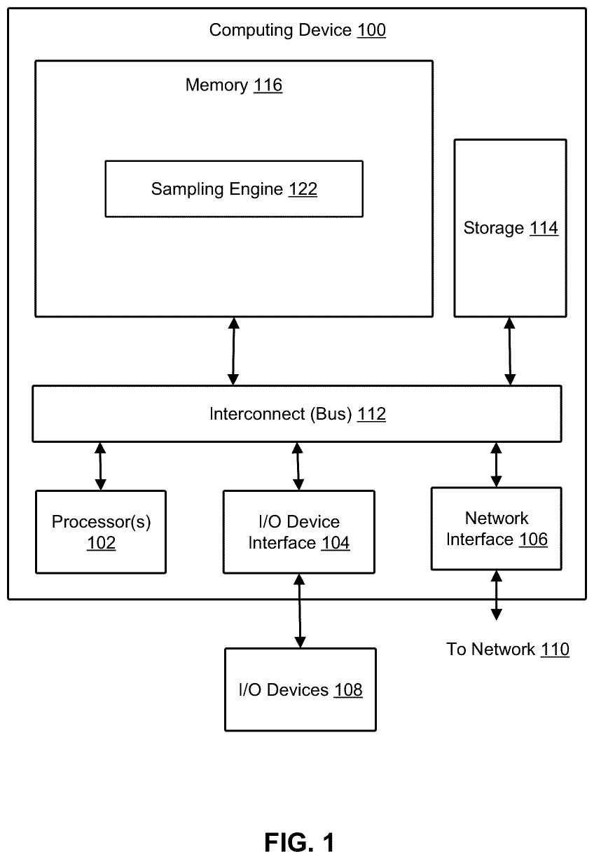

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a sampling engine 122 that resides in a memory 116.

It is noted that the computing device described herein is illustrative and that any other technically feasible configurations fall within the scope of the present disclosure. For example, multiple instances of sampling engine 122 could execute on a set of nodes in a distributed and/or cloud computing system to implement the functionality of computing device 100. In another example, sampling engine 122 could execute on various sets of hardware, types of devices, or environments to adapt sampling engine 122 to different use cases or applications. In a third example, sampling engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Sampling engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including sampling engine 122.

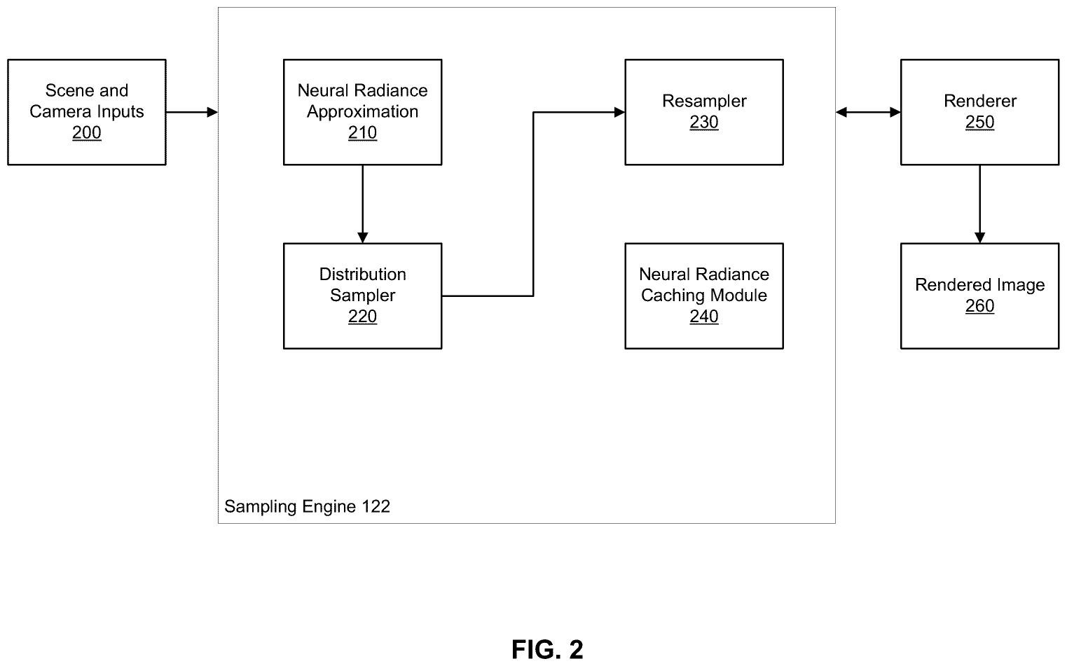

FIG. 2 is a more detailed illustration of sampling engine 122 of FIG. 1, according to some embodiments. Sampling engine 122 generates lightpaths associated with a 3D scene based on scene and camera inputs 200, and transmits the generated lightpaths to a renderer 250 that generates a rendered image 260 of the 3D scene. Sampling engine 122 includes, without limitation, neural radiance approximation 210, distribution sampler 220, resampler 230, and neural radiance caching module 240.

Scene and camera inputs 200 include a representation of a 3D scene, where the 3D scene includes one or more objects and one or more light sources. The representation of the 3D scene includes geometry, texture, lighting, and/or shading information describing the scene. In particular, the representation may include information describing the one or more objects included in the 3D scene, such as position, size, shape, texture, surface normal, albedo, and roughness. The representation may may also include information describing the one or more light sources included in the 3D scene, such as positions, intensities, or light color. In various embodiments, the representation of the 3D scene may include positions expressed in a world coordinate system associated with the 3D scene.

Scene and camera inputs 200 may also describe a viewpoint associated with a virtual camera, where the viewpoint includes a location associated with the virtual camera and an orientation associated with the virtual camera. In various embodiments, the location of the virtual camera may be expressed in the world coordinate system associated with the 3D scene, and the camera orientation may be expressed as, e.g., vertical and/or horizontal angular displacements from a neutral or baseline camera orientation. Rendered image 260 discussed below includes a 2D depiction of the 3D scene from the viewpoint of the virtual camera.

### Lightpath Construction and Direction Sampling

Sampling engine 122 generates multiple lightpaths associated with the 3D scene. A lightpath originates at the virtual camera location and proceeds to a scattering location x located in the scene, where the scattering location x may include any point within the 3D scene. From scattering location x, sampling engine 122 selects an outgoing direction in which the lightpath continues traveling through the 3D scene. The lightpath may continue to one or more additional scattering locations included in the 3D scene, until the lightpath exits the 3D scene or reaches a light source included in the 3D scene. A generated lightpath that reaches a light source may therefore connect the light source to the virtual camera directly. Alternatively, a generated lightpath that reaches a light source may connect the light source to the virtual camera indirectly through one or more scattering locations included in the 3D scene. A renderer may determine color or other characteristics associated with scattering location x based on the cumulative lighting effects from the light source to the virtual camera, potentially including the effects of light scattering or reflection from one or more scattering locations included in the lightpath between the light source and scattering location x.

A generated lightpath from the virtual camera to scattering location x that later exits the 3D scene (possibly after multiple scattering or reflection events) without reaching a light source included in the 3D scene does not contribute to color or other characteristics associated with scattering location x. Therefore, when selecting an outgoing direction from which the lightpath is to leave a point, it is desirable to select the outgoing direction based on an amount of light reflected from the scattering location in the direction of the incoming lightpath. Sampling engine 122 samples directions ωᵢ at every point in the scene x with a distribution p that is (approximately) proportional to the amount of reflected light Lᵣ from ωᵢ at x towards the direction ωₒ that the lightpath came from:

$$p ( {ω}_{i} \vert x , {ω}_{o} ) ∝ {L}_{r} ( {ω}_{i} \vert x , {ω}_{o} ) \qquad Equation ( 1 )$$

The probability distribution p of Equation (1) will therefore favor outgoing directions ωᵢ that are associated with larger amounts of reflected light Lᵣ. In various embodiments, sampling engine 122 may evaluate the Lᵣ(ωᵢ|x, ωₒ) term included in Equation (1) by decomposing the term into the product of a BxDF ƒ and the incident radiance Lᵢ:

$${L}_{r} ( {ω}_{i} \vert x , {ω}_{o} ) = f ( {ω}_{i} \vert x , {ω}_{o} ) {L}_{i} ( {ω}_{i} \vert x ) \qquad Equation ( 2 )$$

In Equation (2), BxDF ƒ includes any bidirectional scattering distribution function known in the art, such as a Bidirectional Reflected Distribution Function (BRDF), a Bidirectional Transmittal Distribution Function (BTDF), or a Bidirectional Scattering-Surface Reflectance Distribution Function (BSSRDF). In various embodiments, the BxDF ƒ may also incorporate one or more phase functions that describe the scattering of light incident on a volumetric participating media included in the 3D scene, such as smoke, fog, clouds, or fire. The BxDF ƒ may be evaluated at inference time via a renderer, such as renderer 250 discussed below, based on information included in scene and camera inputs 200 that describes the various objects and surfaces included in a 3D scene.

The incident radiance term Lᵢ(ωᵢ|x) represents an amount of light incident on point x from a direction ωᵢ. The incident radiance term Lᵢ influences the amount of reflected light Lᵣ, as shown in Equation (2). In turn, the reflected light term Lᵣ influences the probability distribution p given by Equation (1). Consequently, the probability distribution p will, for a given BxDF ƒ, favor directions ωᵢ from which greater amounts of incident light are received. For example, if multiple light sources included in the 3D scene directly illuminate a point x from different directions ωᵢ the probability distribution p will favor a direction corresponding to a brighter light source included in the multiple light sources over a direction corresponding to a dimmer light source.

The incident radiance term Lᵢ(ωᵢ|x) is generally not known at inference time, prior to lightpath construction. Sampling engine 122 learns incident radiance characteristics associated with each point x included in the 3D scene via neural radiance approximation 210.

Neural radiance approximation 210 includes a neural network \hat{N} with parameters ϕ. Sampling engine 122 approximates Lᵢ(ωᵢ|x) with \hat{N}(ωᵢ|x, r(x),ϕ) by adjusting the parameters ϕ using backpropagation during inference as discussed below. Neural network \hat{N} of neural radiance approximation 210 also depends on r(x), where r(x) includes a vector of additional features, such as the surface normal, albedo, or roughness that depend on location x in the 3D scene and may be obtained from renderer 250 during path construction.

### Resampled Importance Sampling

In various embodiments, neural network \hat{N} included in neural radiance approximation 210 may be neither invertible nor normalized. Accordingly, sampling engine 122 may not be operable to sample directions directly from neural network \hat{N}. Rather than sampling directions directly from neural network \hat{N}, sampling engine 122 performs Resampled Importance Sampling (RIS) based on neural network Ñ. RIS enables sampling engine 122 to generate multiple samples that approximately follow the reflected radiance function Lᵣ(ωᵢ|x, ωₒ) from Equation (2) based on the incident radiance function Lᵢ(ωᵢ|x) as approximated by neural network Ñ(ωᵢ|x,r(x),ϕ). Specifically, an RIS target function T is given by:

$$T ( {ω}_{i} \vert x , r ( x ) , {ω}_{o} , ϕ ) = f ( {ω}_{i} \vert x , {ω}_{0} ) \hat{N} ( {ω}_{i} \vert x , r ( x ) , ϕ ) \qquad Equation ( 3 )$$

Distribution sampler 220 generates, for a point x included in the 3D scene, a set of M candidate directions vₘ′k={1, . . . , M} in which to potentially extend the lightpath, according to a known probability density function. For example, distribution sampler 220 may generate the set of candidate directions M based on a uniform distribution, a BxDF distribution, a cosine distribution, or a Next Event Estimation (NEE) distribution. For each candidate direction vₘ, distribution sampler 220 calculates an associated source probability density q(vₘ) based on an evaluation of the chosen probability density function. Distribution sampler 220 also calculates a resampling weight associated with the candidate direction vₘ:

$$resampling weight = T ( {v}_{m} ) / q ( {v}_{m} ) \qquad Equation ( 4 )$$

Distribution sampler 220 also calculates the sum W of all of the candidate directions' resampling weights. Distribution sampler 220 transmits the set of M candidate directions, the source probability densities q(vₘ) associated with each candidate direction, and the sum W of all of the candidate directions' resampling weights to resampler 230.

Resampler 230 re-samples, with replacement, N<M candidates from the set of candidate directions with probability q(vₘ)/T(vₘ)W, where T is the RIS target function given by Equation (3). In various embodiments, N may equal 1. Resampler 230 applies a correction factor W/M to quantities obtained based on the re-sampled directions, such as light intensities.

The correction factor reduces bias in the lightpath generation process that may lead to inaccuracies in rendered image 260 discussed below.

Sampling engine 122 may extend the generated lightpath based on the N resampled candidate directions. In various embodiments where N=1, sampling engine 122 extends the generated lightpath in the direction specified by the resampled candidate direction until the generated lightpath reaches another scattering location x included in the 3D scene, until the generated lightpath reaches a light source included in the 3D scene, or until the generated lightpath exits the 3D scene. A scattering location x included in the 3D scene may be located on a surface depicted in the 3D scene, or may be located within a volumetric element included in the 3D scene, e.g., smoke, clouds, fog, or fire. Consequently, the scattering location x may be located at any position within the 3D scene. If the generated lightpath reaches another scattering location x included in the 3D scene, sampling engine 122 repeats the above sampling and resampling processes at the new scattering location x and continues constructing the lightpath. In various embodiments, sampling engine 122 may terminate the generation of a lightpath that has not reached a light source after a predetermined number of intersections with multiple scattering locations x included in the 3D scene. If a generated lightpath reaches a light source included in the 3D scene that does not itself reflect light from one or more additional light sources included in the 3D scene, the generated lightpath is complete, and connects the light source to the virtual camera from which the generated lightpath originated. Sampling engine 122 transmits the completed lightpath to renderer 250. Sampling engine 122 may further generate additional light paths as described above, beginning at the virtual camera location and initially extending into different regions of the 3D scene.

Renderer 250 may be any computer graphics renderer that is suitable to generate, based on multiple received lightpaths, a 2D depiction of a 3D scene as viewed from a virtual camera position, where a description of the 3D scene and the viewpoint of the virtual camera are included in scene and camera inputs 200. In various embodiments, renderer 250 may begin at one end of a received lightpath corresponding to the virtual camera. Renderer 250 may traverse the received lightpath from the virtual camera to the light source, calculating values describing lighting effects associated with the direct or indirect interaction of light from the light source with one or more scattering locations x included in the 3D scene that lie along the lightpath. For example, for a scattering location x included in the 3D scene and lying along the lightpath, renderer 250 may determine a color value associated with scattering location x. In various embodiments, the color determination may be based on a direction w; from which incoming direct or indirect light reaches scattering location x, a direction ωₒ in which scattered and/or reflected light leaves scattering location x towards the virtual camera, and one or more surface or media characteristics associated with scattering location x. As discussed above, the one or more surface or media characteristics may include texture, surface normal, albedo, and roughness characteristics received in scene and camera inputs 200. Based on the determined color values associated with multiple points included in the 3D scene, renderer 250 generates rendered image 260.

Rendered image 260 includes a 2D representation of the 3D scene as viewed from the virtual camera viewpoint, where the virtual scene and virtual camera are described in scene and camera inputs 200. In various embodiments, rendered image 260 may include a 2D raster image having a rectangular arrangement of pixels. Each of the pixels may include one or more associated values, such as color or transparency values.

In various embodiments, the 3D scene and virtual camera viewpoint included in scene and camera inputs 200 may represent a single frame of multiple frames included in a video sequence depicting the 3D scene. In these embodiments, rendered image 260 may include a 2D representation of the 3D scene corresponding to the 3D scene and virtual camera viewpoint included in scene and camera inputs 200.

### Training the Neural Radiance Approximation

As described above, the neural network \hat{N}(ωᵢ|x, r(x),ϕ) included in neural radiance approximation 210 estimates the incident radiance at a point x received from an incidence direction ωᵢ, based on at least parameters ϕ. For a given completed lightpath received from sampling engine 122, renderer 250 may generate ground truth incident radiance values for one or more points included in the received lightpath, based on known light transport functions, such as BxDF functions. In various embodiments, sampling engine 122 may include one or more loss functions (not shown), where a value associated with a loss function represents a difference between a ground truth incident radiance value calculated by renderer 250 and an estimated incident radiance value estimated by neural radiance approximation 210. For example, a loss function may include a mean-squared error (MSE) evaluation of differences between ground truth and estimated incident radiance values. Sampling engine 122 may modify one or more parameters ϕ included in neural network \hat{N} via backpropagation, based on the one or more loss function values.

In various embodiments, sampling engine 122 may initialize one or more parameters ϕ included in neural network \hat{N} to predetermined default values, and periodically modify the parameters ϕ during inference based on the one or more loss function values. In other embodiments, sampling engine 122 may initialize one or more parameters ϕ included in neural network \hat{N} to predetermined default values, and repeatedly modify the parameters ϕ for a predetermined number of iterations as sampling engine 122 generates completed lightpaths. After the predetermined number of iterations have completed, the parameters ϕ included in neural network Ñ may remain fixed while sampling engine 122 generates subsequent lightpaths. In various embodiments where scene and camera inputs 200 includes multiple frames of a video sequence depicting the 3D scene, sampling engine 122 may continue to use the modified parameters ¢ included in neural network \hat{N} when generating lightpaths associated with subsequent frames of the video sequence.

### Separating Light Transport

In various embodiments, sampling engine 122 may decompose the incident radiance term Lᵢ(ωᵢ|x) of Equation (2) into a sum of the direct illumination and the indirect illumination incident on a point x:

$${L}_{i} ( {ω}_{i} \vert x ) = {L}_{i , direct} ( {ω}_{i} \vert x ) + {L}_{i , indirect} ( {ω}_{i} \vert x ) \qquad Equation ( 5 )$$

In these embodiments, neural radiance approximation 210 may include separate neural networks to estimate each of indirect incident radiance Lᵢ, direct (ωᵢ|x) and direct incident radiance L_{i, indirect} (ωᵢ|x) included in Equation (5), rather than a single neural network Ñ as discussed above. In these embodiments, each separate neural network learns and specializes on a specific type of light transport, i.e., direct or indirect lighting, and distribution sampler 220 may include multiple transport-specific candidate sampling functions. In various embodiments, the incidence radiance at a point x may be further decomposed into more components, including but not limited to, caustic light transport, illumination from volume interactions, or illumination from a discrete number of indirect light bounces in a lightpath.

Combination with Neural Radiance Caches

In various embodiments, sampling engine 122 may include neural radiance caching module 240 that learns an approximation \hat{M} of the integrated reflected radiance into a direction ωₒ from a point x:

$${L}_{r} ( {ω}_{o} , x ) = {\int }_{Ω} f ( {ω}_{i} \vert x , {ω}_{o} ) {L}_{i} ( {ω}_{i} \vert x ) d {ω}_{i} \qquad Equation ( 6 )$$

In various embodiments, approximation \hat{M} represents a neural radiance cache, and may include a neural network similar in operation to \hat{N} described above. For a given combination of a point x included in a 3D scene and a direction ωₒ from which a lightpath reaches point x, sampling engine 122 determines if neural radiance caching module already includes an approximation of the integrated reflected radiance into direction ωₒ from point x. This approximation may be based on previous lightpath generation iterations, where sampling engine 122 generated one or more lightpath segments beyond point x, eventually reaching a light source included in the 3D scene. In these instances, sampling engine 122 may exit the lightpath generation process early by utilizing the approximation \hat{M} evaluated at ωₒ, x, rather than continuing to generate additional lightpath segments beyond point x. Similar to training \hat{N}, sampling engine 122 may train approximation \hat{M} based on ground truth reflected radiance values associated with point x and direction ωₒ. In various embodiments, sampling engine 122 may also train \hat{M} based on lightpaths that lookup into the neural radiance cache itself, similar to temporal-difference learning in reinforcement learning techniques. These neural radiance caching techniques may greatly reduce the number of lightpaths that sampling engine 122 must generate to completion, i.e., until the lightpath reaches a light source included in the 3D scene.

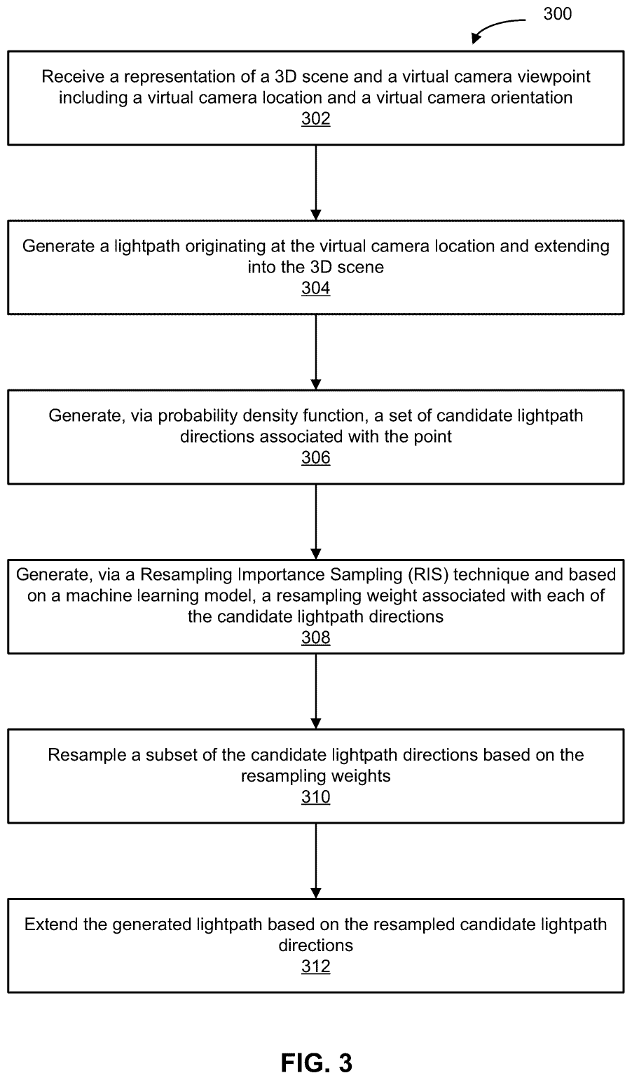

FIG. 3 is a flow diagram of method steps for sampling and resampling candidate lightpaths included in a 3D scene, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, sampling engine 122 receives scene and camera inputs 200. Scene and camera inputs 200 include a representation of a 3D scene, where the 3D scene includes one or more objects and one or more light sources. The representation of the 3D scene includes geometry, texture, lighting, and/or shading information describing the scene. In particular, the representation may include information describing the one or more objects included in the 3D scene, such as position, size, shape, texture, surface normal, albedo, and roughness. The representation may also include information describing the one or more light sources included in the 3D scene, such as positions, intensities, or light color. In various embodiments, the representation of the 3D scene may include positions expressed in a world coordinate system associated with the 3D scene.

Scene and camera inputs 200 may also describe a viewpoint associated with a virtual camera, where the viewpoint includes a location associated with the virtual camera and an orientation associated with the virtual camera. In various embodiments, the location of the virtual camera may be expressed in the world coordinate system associated with the 3D scene, and the camera orientation may be expressed as, e.g., vertical and/or horizontal angular displacements from a neutral or baseline camera orientation. Rendered image 260 discussed below includes a 2D depiction of the 3D scene from the viewpoint of the virtual camera.

In step 304, sampling engine 122 generates a lightpath originating at the virtual camera location and extending in a chosen direction into the 3D scene. If the chosen direction causes the generated lightpath to exit the 3D scene without reaching an object, surface, or light source included in the 3D scene, sampling engine 122 discards the generated lightpath, as the generated lightpath may not be suitable for rendering a 2D depiction of the 3D scene.

If the generated lightpath extends directly from the virtual camera location to a location associated with a light source included in the 3D scene, sampling engine 122 evaluates the generated lightpath as complete and transmits the completed lightpath to renderer 250. Renderer 250 may determine one or more values for pixels included in rendered image 260 based on the completed lightpath.

If the generated lightpath reaches a point x included in the 3D scene and associated with an object or surface included in the 3D scene, sampling engine 122 calculates a direction in which to extend the generated lightpath further into the scene via a path guiding process based on a set of candidate lightpath directions.

In step 306, distribution sampler 220 of sampling engine 122 generates set of M candidate directions vₘ′k={1, . . . , M} in which to potentially extend the lightpath from point x, according to a known probability density function. For example, distribution sampler 220 may generate the set of candidate directions M based on a uniform distribution, a BxDF distribution, a cosine distribution, or a Next Event Estimation (NEE) distribution. For each candidate direction vₘ, distribution sampler 220 calculates an associated source probability density q(vₘ) based on an evaluation of the chosen probability density function at candidate direction vₘ and point x.

In step 308, distribution sampler of sampling engine 122 also generates a resampling weight associated with each of the candidate directions vₘ′k={1, . . . , M}, based on a Resampling Importance Sampling (RIS) technique:

$$resampling weight = T ( {v}_{m} ) / q ( {v}_{m} ) \qquad Equation ( 4 )$$

The term T in Equation (4) represents an RIS target function:

$$T ( {ω}_{i} \vert x , r ( x ) , {ω}_{o} , ϕ ) = f ( {ω}_{i} \vert x , {ω}_{0} ) \hat{N} ( {ω}_{i} \vert x , r ( x ) , ϕ ) \qquad Equation ( 3 )$$

The function ƒ(ωᵢ|x,ωₒ) of Equation (3) includes a known bidirectional distribution function, such as a Bidirectional Reflected Distribution Function (BRDF), a Bidirectional Transmittal Distribution Function (BTDF), or a Bidirectional Scattering-Surface Reflectance Distribution Function (BSSRDF). The bidirectional distribution function may be retrieved from renderer 250, and describes the behavior of light incident on a surface, such as scattering, reflectance, and/or transmittal.

The term \hat{N}(ωᵢ|x,r(x),ϕ) of Equation (3) represents neural radiance approximation 210 that includes a neural network \hat{N} with parameters ϕ. Sampling engine 122 approximates light incident on point x from a candidate direction ωᵢ with neural network \hat{N}(ωᵢ|x, r(x),ϕ) Neural network \hat{N} of neural radiance approximation 210 also depends on r(x), where r(x) includes a vector of additional features, such as the surface normal, albedo, or roughness that depend on location x in the 3D scene and may be obtained from renderer 250 during path construction. Equation (3) estimates an amount of incident light at point x arriving from direction w; that is reflected from point x in a direction ω₀ from which the lightpath reached point x. Distribution sampler 220 transmits the set of M candidate directions, the source probability densities q(vₘ) associated with each candidate direction, and the sum W of all of the candidate directions' resampling weights to resampler 230.

In step 310, resampler 230 of sampling engine 122 selects a subset of the candidate directions. Resampler 230 re-samples, with replacement, N<M candidates from the set of candidate directions with probability q(vₘ)/(T (vₘ)W), where T is the RIS target function given by Equation (3), q(vₘ) represents the source probability density for a particular candidate direction, and W represents the sum of all of the candidate directions' resampling weights. In various embodiments, N may equal 1, and resampler 230 may select a single one of the M candidate directions.

In step 312, sampling engine 122 extends the generated lightpath from point x in the direction of the candidate direction selected by resampler 230. The extended lightpath may then intersect a different point x included in the 3D scene, and sampling engine 122 may repeat one or more of steps 306, 308, 310, and 312 at the different point x. As described above, sampling engine 122 may discard a lightpath that exits the 3D scene without reaching a light source included in the 3D scene, or may transmit a lightpath that reaches a light source included in the 3D scene to renderer 250.

In sum, the disclosed techniques perform path guiding for Monte Carlo Path Tracing (MCPT) to generate lightpaths associated with a representation of a 3D scene. Specifically, the disclosed techniques generate multiple sample directions for a lightpath at every point included in the 3D scene, based on a distribution that is approximately proportional to the amount of light reaching the point from the sample direction and reflected in a direction from which the lightpath reaches the point. The reflected light is based on one or more known distribution functions and an incident radiance term. The incident radiance term is based on a learned neural function that represents light properties associated with the 3D scene.

In various embodiments, the learned neural function is neither invertible nor normalized, and is not operable to be sampled directly to determine incident radiance at a particular point in the 3D scene from a particular direction. The disclosed techniques perform Resampled Importance Sampling (RIS) to sample indirectly from the learned neural function. RIS is operable to generate one or more samples associated with a point in the 3D scene and having a distribution that approximates the learned neural function. The disclosed RIS techniques leverage the greater expressive power and accuracy of the learned neural function, while being operable to generate samples whether the learned neural function is invertible, non-invertible, normalized, or non-normalized.

In operation, a sampling engine receives a representation of a 3D scene, and a viewpoint associated with a virtual camera. The representation describes the contents of the 3D scene, including object locations and geometry, surface characteristics, and one or more light sources. The viewpoint associated with the virtual camera may include a location and an orientation associated with the virtual camera.

The sampling engine generates a lightpath that originates at the virtual camera location and extends into the 3D scene. For each point x included in the 3D scene and reached by the lightpath, the sampling engine selects multiple candidate directions in which to potentially extend the lightpath from point x to another location in the 3D scene. The sampling engine selects the multiple candidate directions using a distribution p that is approximately proportional to the amount of reflected light Lᵣ from direction ωᵢ at point x towards the direction ωₒ that the path came from. The sampling engine decomposes the reflected light Lᵣ into the product of a bidirectional scattering distribution function ƒ and an incident radiance Lᵢ arriving at point x from the candidate direction.

While the bidirectional scattering distribution function ƒ is available at inference time, the sampling engine estimates incident radiance Lᵢ at point x based on a neural network representation \hat{N} of the lighting characteristics associated with the 3D scene. The neural representation \hat{N} might not be invertible or normalized, and therefore may not be operable to generate sample directions directly. The sampling engine utilizes a Resampled Importance Sampling (RIS) to generate samples based on neural network representation \hat{N}, rather than sampling Ñ directly.

The sampling engine first generates a set of M candidate directions in which to potentially extend the lightpath. The sampling engine generates this set of M candidate directions based on a readily available probability density function, such as a bidirectional scattering distribution function, a uniform distribution, a cosine distribution, or a Next Event Estimation (NEE) function. The sampling engine then calculates a probability density value for each of the M candidate directions based on the chosen probability density function. The sampling engine then resamples, with replacement, N<M candidates from the set of M candidate directions, based on the probability density values associated with each of the M candidate directions and a RIS target function T. The RIS target function T represents the product of the bidirectional scattering distribution function ƒ and the neural approximation of the incident light Lᵢ estimated by neural network \hat{N}. In various embodiments, the sampling engine resamples a single one of the M candidate directions, i.e., N=1, and extends the lightpath in the resampled candidate direction. Generated lightpaths that exit the 3D scene without reaching a light source are generally not useful for creating a 2D rendering of the 3D scene. The RIS technique ensures that candidate directions are resampled proportionally to the distribution of the reflected radiance at point x, increasing the likelihood that the lightpath, when extended in the resampled direction, will eventually reach a light source included in the 3D scene, possibly after being redirected at one or more subsequently reached points included in the 3D scene.

One technical advantage of the disclosed techniques relative to the prior art is that the disclosed techniques include an expressive, accurate learned neural representation of incident and/or reflected radiance associated with a scene, rather than a limited parametric model. However, the disclosed techniques are operable to sample from a parametric model as well. Further, the disclosed techniques do not require that the learned neural representation be invertible or normalized, although they are also operable to sample invertible and/or normalized learned neural representations. These techniques reduce the necessary complexity of the neural representation and increase the accuracy of the final rendered image. These technical advantages provide one or more improvements over prior art approaches.

1. In some embodiments, a computer-implemented method for performing path guiding, the computer-implemented method comprises receiving a representation of a three-dimensional (3D) scene and a virtual camera location, generating a lightpath that originates at the virtual camera location and reaches a point included in the 3D scene, selecting, from a set of candidate directions, a direction in which to extend the generated lightpath from the point, wherein the selecting is based at least on one or estimates of incident light characteristics associated with the 3D scene and predicted by a machine learning model, extending the generated lightpath in the selected direction, and generating a two-dimensional (2D) rendering of the 3D scene based at least on the generated lightpath.

2. The computer-implemented method of clause 1, wherein the representation of the 3D scene includes surface or lighting characteristics associated with one or more objects, surfaces, or light sources included in the 3D scene.

3. The computer-implemented method of clauses 1 or 2, further comprising generating the set of candidate directions based on a distribution function, wherein the distribution function includes a uniform distribution, a bidirectional scattering distribution function (BxDF) distribution, a cosine distribution, or a Next Event Estimation (NEE) distribution.

4. The computer-implemented method of any of clauses 1-3, wherein the machine learning model includes a neural network that estimates an amount of incident light arriving at the point included in the 3D scene from a given direction.

5. The computer-implemented method of any of clauses 1-4, wherein selecting the direction in which to extend the generated lightpath is further based on a bidirectional scattering distribution function (BxDF).

6. The computer-implemented method of any of clauses 1-5, further comprising approximating, via a neural radiance cache, an integrated amount of reflected radiance from the point included in the 3D scene into a direction from which the lightpath reached the point.

7. The computer-implemented method of any of clauses 1-6, wherein the machine learning model includes a first neural network that estimates an amount of incident direct illumination at the point included in the 3D scene and a second neural network that estimates an amount of incident indirect illumination at the point included in the 3D scene.

8. The computer-implemented method of any of clauses 1-7, further comprising discarding a generated lightpath that exits the 3D scene without reaching any of one or more light sources included in the 3D scene.

9. The computer-implemented method of any of clauses 1-8, further comprising generating, for each candidate direction included in the set of candidate directions, a resampling weight associated with the candidate direction.

10. In some embodiments, one or more non-transitory computer-readable media store instructions that, when executed by one or more processors, cause the one or more processors to perform the steps of receiving a representation of a three-dimensional (3D) scene and a virtual camera location, generating a lightpath that originates at the virtual camera location and reaches a point included in the 3D scene, selecting, from a set of candidate directions, a direction in which to extend the generated lightpath from the point, wherein the selecting is based at least on one or estimates of incident light characteristics associated with the 3D scene and predicted by a machine learning model, extending the generated lightpath in the selected direction, and generating a two-dimensional (2D) rendering of the 3D scene based at least on the generated lightpath.

11. The one or more non-transitory computer-readable media of clause 10, wherein the representation of the 3D scene includes surface or lighting characteristics associated with one or more objects, surfaces, or light sources included in the 3D scene.

12. The one or more non-transitory computer-readable media of clauses 10 or 11, wherein the steps further comprise generating the set of candidate directions based on a distribution function, wherein the distribution function includes a uniform distribution, a bidirectional scattering distribution function (BxDF) distribution, a cosine distribution, or a Next Event Estimation (NEE) distribution.

13. The one or more non-transitory computer-readable media of any of clauses 10-12, wherein the machine learning model includes a neural network that estimates an amount of incident light arriving at the point included in the 3D scene from a given direction.

14. The one or more non-transitory computer-readable media of any of clauses 10-13, wherein the step of selecting the direction in which to extend the generated lightpath is further based on a bidirectional scattering distribution function (BxDF).

15. The one or more non-transitory computer-readable media of any of clauses 10-14, wherein the steps further comprise approximating, via a neural radiance cache, an integrated amount of reflected radiance from the point included in the 3D scene into a direction from which the lightpath reached the point.

16. The one or more non-transitory computer-readable media of any of clauses 10-15, wherein the machine learning model includes a first neural network that estimates an amount of incident direct illumination at the point included in the 3D scene and a second neural network that estimates an amount of incident indirect illumination at the point included in the 3D scene.

17. The one or more non-transitory computer-readable media of any of clauses 10-16, wherein the steps further comprise discarding a generated lightpath that exits the 3D scene without reaching any of one or more light sources included in the 3D scene.

18. The one or more non-transitory computer-readable media of any of clauses 10-17, further comprising generating, for each candidate direction included in the set of candidate directions, a resampling weight associated with the candidate direction.

19. In some embodiments, a system comprises one or more memories storing instructions, and one or more processors for executing the instructions to receive a representation of a three-dimensional (3D) scene and a virtual camera location, generate a lightpath that originates at the virtual camera location and reaches a point included in the 3D scene, select, from a set of candidate directions, a direction in which to extend the generated lightpath from the point, wherein the selecting is based at least on one or estimates of incident light characteristics associated with the 3D scene and predicted by a machine learning model, extend the generated lightpath in the selected direction, and generate a two-dimensional (2D) rendering of the 3D scene based at least on the generated lightpath.

20. The system of clause 19, wherein the machine learning model includes a neural network that estimates an amount of incident light arriving at the point included in the 3D scene from a given direction.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing path guiding, the computer-implemented method comprising:
receiving a representation of a three-dimensional (3D) scene and a virtual camera location;
generating a lightpath that originates at the virtual camera location and reaches a point included in the 3D scene;
selecting, from a set of candidate directions, a direction in which to extend the generated lightpath from the point, wherein the selecting is based at least on one or estimates of incident light characteristics associated with the 3D scene and predicted by a machine learning model;
extending the generated lightpath in the selected direction; and
generating a two-dimensional (2D) rendering of the 3D scene based at least on the generated lightpath.

2. The computer-implemented method of claim 1, wherein the representation of the 3D scene includes surface or lighting characteristics associated with one or more objects, surfaces, or light sources included in the 3D scene.

3. The computer-implemented method of claim 1, further comprising generating the set of candidate directions based on a distribution function, wherein the distribution function includes a uniform distribution, a bidirectional scattering distribution function (BxDF) distribution, a cosine distribution, or a Next Event Estimation (NEE) distribution.

4. The computer-implemented method of claim 1, wherein the machine learning model includes a neural network that estimates an amount of incident light arriving at the point included in the 3D scene from a given direction.

5. The computer-implemented method of claim 1, wherein selecting the direction in which to extend the generated lightpath is further based on a bidirectional scattering distribution function (BxDF).

6. The computer-implemented method of claim 1, further comprising approximating, via a neural radiance cache, an integrated amount of reflected radiance from the point included in the 3D scene into a direction from which the lightpath reached the point.

7. The computer-implemented method of claim 1, wherein the machine learning model includes a first neural network that estimates an amount of incident direct illumination at the point included in the 3D scene and a second neural network that estimates an amount of incident indirect illumination at the point included in the 3D scene.

8. The computer-implemented method of claim 1, further comprising discarding a generated lightpath that exits the 3D scene without reaching any of one or more light sources included in the 3D scene.

9. The computer-implemented method of claim 1, further comprising generating, for each candidate direction included in the set of candidate directions, a resampling weight associated with the candidate direction.

10. One or more non-transitory computer-readable media storing instructions that, when executed by one or more processors, cause the one or more processors to perform the steps of:
receiving a representation of a three-dimensional (3D) scene and a virtual camera location;
generating a lightpath that originates at the virtual camera location and reaches a point included in the 3D scene;
selecting, from a set of candidate directions, a direction in which to extend the generated lightpath from the point, wherein the selecting is based at least on one or estimates of incident light characteristics associated with the 3D scene and predicted by a machine learning model;
extending the generated lightpath in the selected direction; and
generating a two-dimensional (2D) rendering of the 3D scene based at least on the generated lightpath.

11. The one or more non-transitory computer-readable media of claim 10, wherein the representation of the 3D scene includes surface or lighting characteristics associated with one or more objects, surfaces, or light sources included in the 3D scene.

12. The one or more non-transitory computer-readable media of claim 10, wherein the steps further comprise generating the set of candidate directions based on a distribution function, wherein the distribution function includes a uniform distribution, a bidirectional scattering distribution function (BxDF) distribution, a cosine distribution, or a Next Event Estimation (NEE) distribution.

13. The one or more non-transitory computer-readable media of claim 10, wherein the machine learning model includes a neural network that estimates an amount of incident light arriving at the point included in the 3D scene from a given direction.

14. The one or more non-transitory computer-readable media of claim 10, wherein the step of selecting the direction in which to extend the generated lightpath is further based on a bidirectional scattering distribution function (BxDF).

15. The one or more non-transitory computer-readable media of claim 10, wherein the steps further comprise approximating, via a neural radiance cache, an integrated amount of reflected radiance from the point included in the 3D scene into a direction from which the lightpath reached the point.

16. The one or more non-transitory computer-readable media of claim 10, wherein the machine learning model includes a first neural network that estimates an amount of incident direct illumination at the point included in the 3D scene and a second neural network that estimates an amount of incident indirect illumination at the point included in the 3D scene.

17. The one or more non-transitory computer-readable media of claim 10, wherein the steps further comprise discarding a generated lightpath that exits the 3D scene without reaching any of one or more light sources included in the 3D scene.

18. The one or more non-transitory computer-readable media of claim 10, further comprising generating, for each candidate direction included in the set of candidate directions, a resampling weight associated with the candidate direction.

19. A system comprising:
one or more memories storing instructions; and
one or more processors for executing the instructions to:
receive a representation of a three-dimensional (3D) scene and a virtual camera location;
generate a lightpath that originates at the virtual camera location and reaches a point included in the 3D scene;
select, from a set of candidate directions, a direction in which to extend the generated lightpath from the point, wherein the selecting is based at least on one or estimates of incident light characteristics associated with the 3D scene and predicted by a machine learning model;
extend the generated lightpath in the selected direction; and
generate a two-dimensional (2D) rendering of the 3D scene based at least on the generated lightpath.

20. The system of claim 19, wherein the machine learning model includes a neural network that estimates an amount of incident light arriving at the point included in the 3D scene from a given direction.
